(19) United States
(12) Patent Application Publication
(10) Pub. No.: US 2024/0387898 A1
(43) Pub. Date: Nov. 21, 2024

(54) ELECTRIC VEHICLE BATTERY BUS BAR TEMPERATURE REGULATION SYSTEM AND METHOD

(71) Applicant: Polestar Performance AB, Göteborg (SE)

(72) Inventor: Jongseok MOON, Västra Frölunda (SE)

(73) Assignee: Polestar Performance AB, Göteborg (SE)

(21) Appl. No.: 18/686,360

(22) PCT Filed: Aug. 23, 2022
(86) PCT No.: PCT/US2022/041255

§ 371 Date: Feb. 23, 2024

Related U.S. Application Data
(60) Provisional application No. 63/238,002, filed on Aug. 27, 2021.

(51) Int. Cl. H01M 10/625; B60L 50/64; B60L 58/27; H01M 10/615; H01M 10/635; H01M 10/6551; H01M 10/656; H01M 10/6571; H01M 50/249

(52) U.S. Cl. CPC H01M 10/625; B60L 50/64; B60L 58/27; H01M 10/615; H01M 10/635; H01M 10/6551; H01M 10/656; H01M 10/6571; H01M 50/249; H01M 2220/20

(57) ABSTRACT

An integrated bus bar temperature regulation system configured to regulate a temperature of a battery pack including a plurality of battery cells positionable within an electric vehicle, the system, including a battery bus bar having both electrical conductivity and thermal conductivity properties to provide a conduit for electrical energy and thermal energy between the plurality of battery cells within the battery pack, and one or more heating elements configured to heat at least portions of the battery bus bar to maintain select battery cells of the plurality of battery cells within the battery pack within a desired temperature range.

### CROSS-REFERENCE TO RELATED APPLICATION

The present application claims the benefit of U.S. Provisional Application No. 63/238,002 filed Aug. 27, 2021, the disclosure of which is hereby incorporated by reference in its entirety.

### TECHNICAL FIELD

The present disclosure relates generally to battery conditioning of an electric vehicle, and more particularly to a high-voltage battery bus bar configured to regulate the temperature of a battery for optimal performance during use.

### BACKGROUND

Electric vehicles are becoming increasingly popular as consumers look to decrease their environmental impact and improve air quality. Instead of a traditional internal combustion engine, electric vehicles include one or more motors, powered by a rechargeable battery pack. A common battery pack is made up of one or more battery modules, each module containing a plurality of battery cells, which act as galvanic cells when being discharged by converting chemical energy to electrical energy, and electrolytic cells when being recharged by converting electrical energy to chemical energy.

As is well known, these battery cells can generate heat in use during discharge and recharge. A buildup of excessive heat within the battery pack can result in degradation in performance or output of the battery cells. In rare circumstances, where the heat becomes excessive, the battery can ignite and burn, which can result in damage to the vehicle or even potential harm the occupants.

Conversely, relatively low temperatures within the battery pack, for example as a result of the vehicle being exposed to low ambient environmental conditions for an extended period of time, can also result in degradation in performance of the battery cells. In particular, low battery temperatures can result in a decrease in output and a decrease in recharging capacity, which can adversely affect the driving range of the vehicle.

The present disclosure addresses these concerns.

### SUMMARY OF THE DISCLOSURE

Embodiments of the present disclosure provide an electric vehicle powered by a rechargeable battery pack interconnected by a high-voltage battery bus bar, the high-voltage battery bus bar having a dual purpose of enabling the transfer of energy between the individual battery cells and other components of the electric vehicle, and enabling a temperature conditioning of the battery pack for improved output, duration and recharge performance. As heating and cooling of the battery pack can consume electrical energy otherwise available for transportation, in some embodiments, the vehicle can rely on an external power source (e.g., a charging station) to precondition the battery prior to an anticipated use. Further, for energy conservation purposes, temperature regulation or conditioning can be primarily focused on certain cells within the battery pack, thereby taking a more targeted approach to battery cell temperature management, with insulation to aid in the thermal isolation of battery cells, as well as a general retention of a target temperature range within the battery pack.

One embodiment of the present disclosure provides an integrated bus bar temperature regulation system configured to regulate a temperature of a battery pack including a plurality of battery cells positionable within an electric vehicle, including a battery bus bar having both electrical conductivity and thermal conductivity properties to provide a conduit for electrical energy and thermal energy between the plurality of battery cells within the battery pack, and one or more heating elements configured to heat at least portions of the battery bus bar to maintain select battery cells of the plurality of battery cells within the battery pack within a desired temperature range.

In one embodiment, the one or more heating elements are at least one of resistance heating elements, induction heating elements, or a combination thereof. In one embodiment, the system further includes at least one heat sink from which he can be radiated away from the battery bus bar. In one embodiment, the system further includes one or more switches configured to selectively isolate portions of the battery bus bar. In one embodiment, the battery bus bar defines a conduit through which a temperature regulation fluid can selectively flow. In one embodiment, the system further includes one or more valves configured to control a flow of temperature regulation fluid through the conduit. In one embodiment, the system further includes an electronic control unit configured to manage a temperature of the plurality of battery cells. In one embodiment, the system further includes a temperature sensor configured to provide feedback to the electronic control unit.

Another embodiment of the present disclosure provides an electric vehicle including a battery temperature regulation system configured to enable a temperature conditioning of a battery pack for improved output, duration and recharge performance, including a battery pack comprising a plurality of battery cells, a battery bus bar interconnecting the plurality of battery cells, the battery bus bar having both electrical conductivity and thermal conductivity properties to provide a conduit for electrical energy and thermal energy between the plurality of battery cells, and one or more heating elements configured to heat at least portions of the battery bus bar to maintain select battery cells of the plurality of battery cells within the battery pack within a desired temperature range.

Yet another embodiment of the present disclosure provides an electric vehicle rechargeable battery temperature regulation system configured to enable a temperature conditioning of a rechargeable battery pack for improved output, duration and recharge performance, including a battery bus bar interconnecting the plurality of battery cells, the battery bus bar having both electrical conductivity and thermal conductivity properties to provide a conduit for electrical energy and thermal energy between components of the rechargeable battery pack, one or more heating elements configured introduce thermal energy at least portions of the battery bus bar, and an electronic control unit in communication with the temperature sensor, the electronic control unit configured to selectively apply the electrical power to the one or more heating elements to maintain select components of the battery pack within a desired temperature range.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view depicting a vehicle battery pack including an integrated bus bar temperature regulation system for temperature regulation of the battery pack positionable within an electric vehicle, in accordance with an embodiment of the disclosure.

FIG. 2 is a perspective view depicting a vehicle battery pack tray loaded with a plurality of battery pack components, in accordance with an embodiment of the disclosure.

FIG. 3A is a perspective view depicting a portion of the integrated bus bar temperature regulation system, in accordance with an embodiment of the disclosure.

FIG. 3B is a cross-sectional view depicting a portion of the bus bar defining a temperature regulation fluid conduit, in accordance with an embodiment of the disclosure.

FIG. 4 is a block diagram depicting an integrated bus bar temperature regulation system configured for temperature regulation of the battery pack at a target temperature or over a desired range of desirable temperatures.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

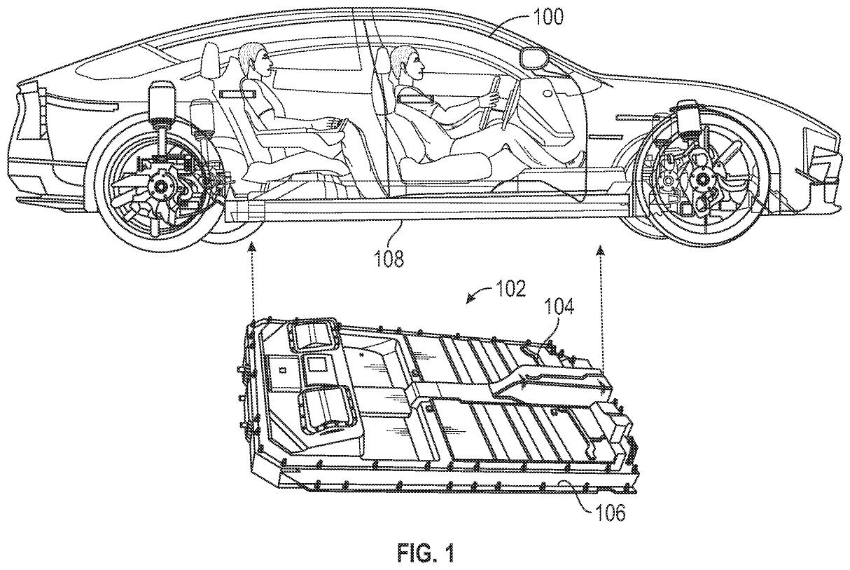

Referring to FIG. 1, an electric vehicle 100 comprising a battery pack 102 including an integrated high-voltage, dual-purpose bus bar temperature regulation system configured to enable the transfer of electrical energy between individual battery cells and other components of the electric vehicle 100, as well as enabling a temperature conditioning of the battery pack 102 for improved output, duration and recharge performance, is depicted in accordance with an embodiment of the disclosure.

Recent studies have indicated that operating an electric vehicle 100 in cold ambient weather conditions can result in a decrease in performance in available range. In particular, some studies suggest that a particular vehicle's range during the colder winter months may be about 60% of a typical expected range during the warmer summer months. Accordingly, it has been observed that optimal battery cell performance is more likely to occur within a desired temperature range (e.g., 40-45° C., etc.), with a maximum/not to exceed temperature (e.g., 60° C.) being above the desired temperature range. With obtaining optimal performance in mind, the integrated high-voltage, dual-purpose bus bar temperature regulation system of the present disclosure enables temperature regulation and preconditioning of the battery pack 102.

As depicted in FIG. 1, the battery pack 102 can include a cover 104 operably coupled to a battery tray 106, thereby creating a sealed battery cell compartment containing clusters of individual battery cells and other battery related components. The assembled battery pack 102 can then be mounted to the frame and/or chassis of the vehicle 100, which in some embodiments can be positioned adjacent to a cabin floor 108 of the vehicle 100, thereby maintaining a low center of gravity.

Various embodiments of the present disclosure will be described in detail with reference to the drawings, wherein like reference numerals represent like parts and assemblies throughout the several views. Various directions and orientations, such as “upward,” “downward,” “top,” “bottom,” “upper,” “lower”, etc. are generally described herein with reference to the drawings in the usual gravitational frame of reference, regardless of how the components may be oriented during assembly.

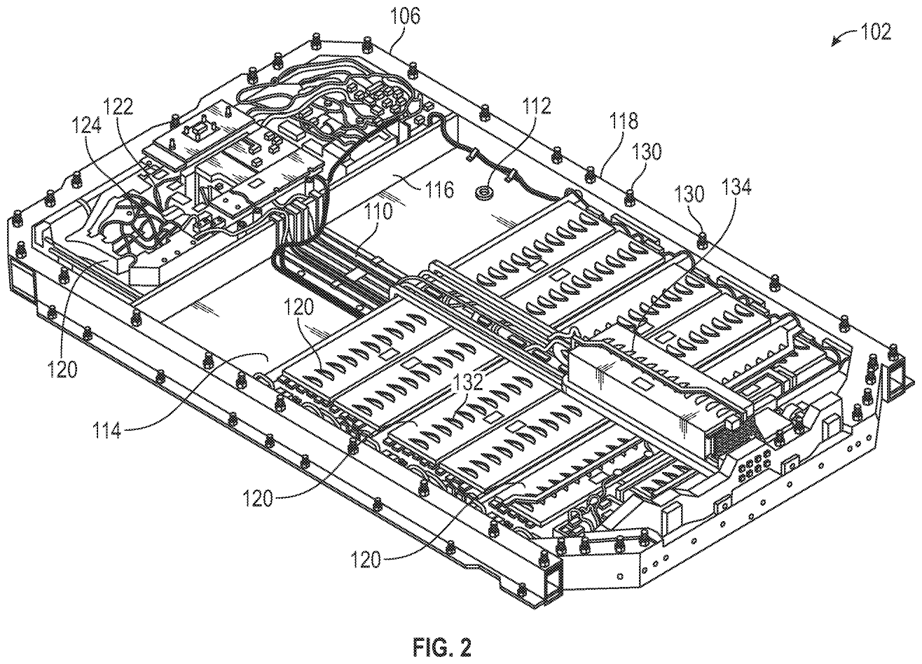

With additional reference to FIG. 2, a battery pack 102 comprising an integrated, high-voltage, battery bus bar temperature regulation system 110, is depicted in accordance with an embodiment of the disclosure. As depicted, the battery tray 106 can represent a bottom and one or more sides of a structural vessel 112 defining a compartment 114. Further, in embodiments, the battery tray 104 can include one or more structural supports, such as cross members 116A-C, which can provide structural support to the battery pack 102, as well as surfaces within the compartment 114 on which other components of the battery pack can be affixed.

In addition to the integrated, high-voltage battery bus bar temperature regulation system 110, a variety of components can be packed into the compartment 114 before the cover 104 (as depicted in FIG. 1) is affixed to a top surface 118 of the battery tray 106, thereby sealing the compartment 114 there within. In some embodiments, the components can include a plurality of battery modules 120, electrical current transmission systems 122, safety systems 124, battery management systems 126 (including current management systems 128), and the like. Once the components have been positioned in the compartment 114, the cover 104 can be affixed to the top surface 118 via a plurality of fasteners 130, adhesive, or a combination thereof.

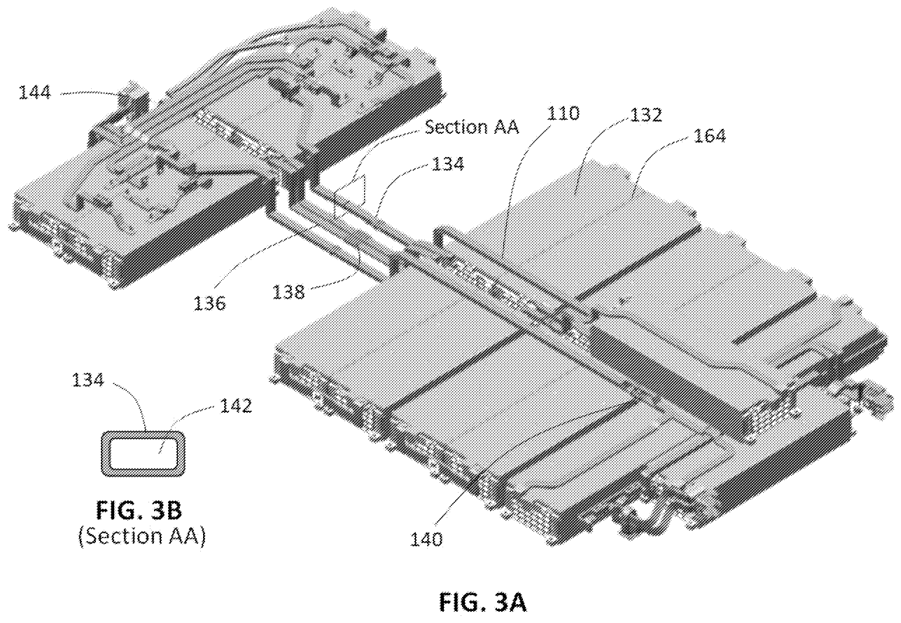

With additional reference to FIG. 3A, the integrated bus bar temperature regulation system 110 can be configured to both enable the transfer of energy between the individual battery cells 132 and other components of the electric vehicle, as well as enable a temperature conditioning of the battery pack 102 for improved output, duration and recharge performance. In some embodiments, the bus bar temperature regulation system 110 can include a bus bar 134, configured to selectively electrically couple the individual battery cells 132 with other components of the electric vehicle (e.g., battery modules, electrical current transmission systems, safety systems, battery management systems, current management systems, and the like).

In addition to serving as an electrical conduit for the various components of the battery pack 102, the bus bar 134 can additionally define a number of other features for improved thermal conditioning. For example, in some embodiments, the bus bar 134 can define one or more heating elements 136 (e.g., resistive heating elements, induction heating elements, etc.), a heat sinks/cooling fins 138 or other projections that increase the surface area from which heat can be radiated away from the bus bar 134, one or more switches 140 configured to selectively isolate portions of the bus bar 134 (thereby enabling activation or deactivation of select heating elements 136, cooling fins 138, etc.), or combinations thereof. Further, in some embodiments, the bus bar 134 can define a conduit 142 (as depicted in FIG. 3B) in which a temperature regulation fluid can selectively flow, the flow of temperature regulation fluid at least partially controllable by one or more valves 144.

As depicted, in some embodiments, the bus bar 134 can be positioned on a top surface of the battery cells 132. In other embodiments, the bus bar 134 can be positioned on the bottom surface of the battery cells 132, potentially concurrent with an existing heat sink or battery cooling panel (e.g., defining a conduit through which a temperature regulation fluid can pass), which in some embodiments can be concurrent with a bottom surface of the battery tray 106. In yet other embodiments, the bus bar 134 can be integrated into the individual battery cells 132, such that the battery pack 102 (including the battery cells 132) is built around the bus bar 134, for example in cell-to-pack (CTP) battery pack arrangements. Other configurations of the bus bar 134 are also contemplated.

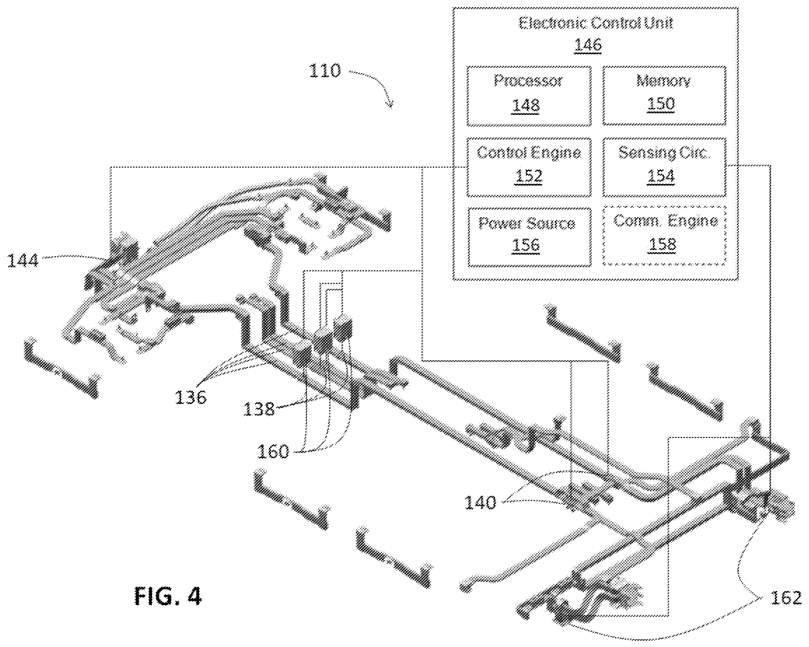

With reference to FIG. 4, in some embodiments, elements of the integrated bus bar temperature regulation system 110 (e.g., heating elements 136, fans 160 associated with the cooling fins 138, switches 140, valves 144, etc.) can be controlled via an electronic control system (ECU) 146. The ECU 146 or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application specific integrated circuit (ASIC) or field programmable gate array (FPGA), for example, or as a combination of hardware and software, such as by a microprocessor system and a set of program instructions that adapt the engine to implement the particular functionality, which (while being executed) transform the microprocessor system into a special-purpose device.

An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques.

Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

In some embodiments, ECU 146 can include a processor 148, memory 150, a control engine 152, sensing circuitry 154, and a power source 156. Optionally, in embodiments, ECU 146 can further include a communications engine 158. Processor 148 can include fixed function circuitry and/or programmable processing circuitry. Processor 148 can include any one or more of a microprocessor, a controller, a DSP, an ASIC, an FPGA, or equivalent discrete or analog logic circuitry. In some examples, processor 148 can include multiple components, such as any combination of one or more microprocessors, one or more controllers, one or more DSPs, one or more ASICs, or one or more FPGAs, as well as other discrete or integrated logic circuitry. The functions attributed to processor 126 herein may be embodied as software, firmware, hardware or any combination thereof.

Memory 150 can include computer-readable instructions that, when executed by processor 148 cause ECU 146 to perform various functions. Memory 150 can include volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

Control engine 152 can include instructions to control the components of ECU 146 and instructions to selectively control electrical power to the heating elements 136, fans 160 associated with the cooling fins 138, switches 140, valves 144, and other components of the integrated bus bar temperature regulation system 110. For example, based on conditions detected by sensing circuitry 154 or the vehicle (e.g. other vehicle ECUs), control engine 152 can selectively activate one or more heating elements 136, activate the one or more cooling fans 138, open/close switches 140, adjust temperature regulation fluid control valves 144, or a combination thereof.

In embodiments, sensing circuitry 154 can be configured to sense one or more signals related to battery temperature. Accordingly, sensing circuitry 154 can include or can be operable with one or more sensors 162 (e.g., one or more thermocouples, etc.). In embodiments, sensing circuitry 154 can additionally include one or more filters and amplifiers for filtering and amplifying signals received from one or more sensors 162.

Accordingly, in some embodiments, the sensing circuitry 154 can monitor a temperature of the individual battery cells 132 or packs of cells with a goal of maintaining the active cells within a desired temperature range. If it is determined by the processor 148 that at least some of the battery cells 132 have dropped below the desired temperature range, the control engine 152 can activate one or more heating elements 136 associated with the below target temperature range battery cells 132.

Conversely, if it is determined by the processor 148 that a temperature of at least some of the battery cells have risen above the desired temperature range, the control engine 152 can open/close one or more switches 140 to route a flow of electrical energy within the bus bar 134 through cooling fins 138, cooling can additionally be affected by activation of one or more cooling fans 160, or by rerouting a flow of electrical energy within the bus bar 134 to allow portions of the bus bar to cool. Additional temperature regulation can be affected through a temperature regulation fluid running through the fluid conduit defined in portions of the bus bar 134. The route another flow characteristics of the temperature regulation fluid can be controlled via one or more valves 144, which are selectively controllable via the control engine 152.

Power source 156 is configured to deliver operating power to the components of ECU 146. Power source 156 can include a battery and a power generation circuit to produce the operating power (e.g., the battery pack 102, individual battery cells 132, etc.). In some examples, the battery is rechargeable to allow extended operation. Power source 156 can include any one or more of a plurality of different battery types, such as nickel cadmium batteries and lithium ion batteries.

Optionally, communications engine 158 can include any suitable hardware, firmware, software, or any combination thereof for communicating with other components of the vehicle and/or external devices (e.g., charging station, etc.). Under the control of processor 148, communication engine 158 can receive downlink telemetry from, as well as send uplink telemetry to one or more external devices using an internal or external antenna. In addition, communication engine 158 can facilitate communication with a networked computing device and/or a computer network.

For example, in some embodiments, the communications engine 136 can be configured to receive information from a driver regarding a desired travel route (e.g., including a desired departure time and en route travel time); for example, in some embodiments, the desired travel route can be obtained from the vehicle's navigation unit (e.g., GPS). In some embodiments, communication engine 136 can additionally be configured to receive or autonomously gather weather data, including an expected ambient environmental temperature along the desired travel route. With this information, the communications engine 136 can communicate with a charging station to regulate the power output of the charging station for desired temperature preconditioning of the battery pack 102 prior to departure. In some embodiments, the integrated bus bar temperature regulation system 110 can suggest additional stops along the desired travel route to obtain additional or updated temperature preconditioning, as well as charging. As an aid in maintaining the battery cells 132 at a particular temperature or range of desired temperatures, in some embodiments, one or more layers of insulation 164 can be positioned in proximity to the battery cells 132 (as depicted in FIG. 3).

In some embodiments, the degree or amount of temperature regulation or battery conditioning can be based on the desired travel route, with the goal of optimizing battery performance. For example, during relatively short travel routes the integrated bus bar temperature regulation system 110 may determine that little to no benefit would be gained by conditioning the battery pack 102. Conversely, for longer travel routes, the system 110 may determine that conditioning the battery pack 102 may be necessary to drive the desired distance in the current ambient temperature conditions along the route. Accordingly, in some embodiments, the system 110 can model possible outcomes (e.g., expected range, battery charge along the route, etc.) based on the known information (e.g., route information, current and forecast weather, current battery charge, etc.) within the range of temperature conditioning controls enabled by the system 110, with the goal of selecting the model that the highest probability of achieving optimal battery performance.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

1. An integrated bus bar temperature regulation system configured to regulate a temperature of a battery pack including a plurality of battery cells positionable within an electric vehicle, the system comprising:
a battery bus bar having both electrical conductivity and thermal conductivity properties to provide a conduit for electrical energy and thermal energy between the plurality of battery cells within the battery pack; and
one or more heating elements configured to heat at least portions of the battery bus bar to maintain select battery cells of the plurality of battery cells within the battery pack within a desired temperature range.

2. The system of claim 1, wherein the one or more heating elements are at least one of resistance heating elements, induction heating elements, or a combination thereof.

3. The system of claim 1, further comprising at least one heat sink from which he can be radiated away from the battery bus bar.

4. The system of claim 1, further comprising one or more switches configured to selectively isolate portions of the battery bus bar.

5. The system of claim 1, wherein the battery bus bar defines a second conduit through which a temperature regulation fluid can selectively flow.

6. The system of claim 5, further comprising one or more valves configured to control a flow of temperature regulation fluid through the conduit.

7. The system of claim 1, further comprising an electronic control unit configured to manage the temperature of the plurality of battery cells.

8. The system of claim 5, further a temperature sensor configured to provide feedback to the electronic control unit.

9. An electric vehicle including a battery temperature regulation system configured to enable a temperature conditioning of a battery pack for improved output, duration and recharge performance, the electric vehicle comprising:
the battery pack comprising a plurality of battery cells;
a battery bus bar interconnecting battery cells included in the plurality of battery cells, the battery bus bar having both electrical conductivity and thermal conductivity properties to provide a conduit for electrical energy and thermal energy between the plurality of battery cells; and
one or more heating elements configured to heat at least portions of the battery bus bar to maintain select battery cells of the plurality of battery cells within the battery pack within a desired temperature range.

10. The system of claim 9, wherein the one or more heating elements are at least one of resistance heating elements, induction heating elements, or a combination thereof.

11. The system of claim 9, further comprising at least one heat sink from which he can be radiated away from the battery bus bar.

12. The system of claim 9, further comprising one or more switches configured to selectively isolate portions of the battery bus bar.

13. The system of claim 9, wherein the battery bus bar defines a second conduit through which a temperature regulation fluid can selectively flow.

14. The system of claim 13, further comprising one or more valves configured to control a flow of temperature regulation fluid through the conduit.

15. An electric vehicle rechargeable battery temperature regulation system configured to enable a temperature conditioning of a rechargeable battery pack for improved output, duration and recharge performance, the system comprising: a battery bus bar interconnecting the plurality of battery cells, the battery bus bar having both electrical conductivity and thermal conductivity properties to provide a conduit for electrical energy and thermal energy between components of the rechargeable battery pack;
one or more heating elements configured introduce thermal energy at least portions of the battery bus bar; and
an electronic control unit in communication with a temperature sensor, the electronic control unit configured to selectively apply the electrical energy to the one or more heating elements to maintain select components of the rechargeable battery pack within a desired temperature range.

16. The system of claim 15, wherein the one or more heating elements are at least one of resistance heating elements, induction heating elements, or a combination thereof.

17. The system of claim 15, further comprising at least one heat sink from which he can be radiated away from the battery bus bar.

18. The system of claim 15, further comprising one or more switches configured to selectively isolate portions of the battery bus bar.

19. The system of claim 15, wherein the battery bus bar defines a second conduit through which a temperature regulation fluid can selectively flow.

20. The system of claim 19, further comprising one or more valves configured to control a flow of temperature regulation fluid through the conduit.
